(19) United States
(12) Patent Application Publication
(10) Pub. No.: US 2003/0231359 A1
(43) Pub. Date: Dec. 18, 2003

(54) Image processing apparatus and paper feed control method

(75) Inventors: Manabu Hayashi, Iwatsuki-shi (JP); Takashi Sakayama, Ebina-shi (JP); Minoru Yoshida, Iwatsuki-shi (JP); Toshitaka Nakagawa, Iwatsuki-shi (JP); Tsuyoshi Watanabe, Iwatsuki-shi (JP); Yuichi Shiho, Iwatsuki-shi (JP); Toshiyu Ishikawa, Iwatsuki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/388,752

(22) Filed: Mar. 17, 2003

(30) Foreign Application Priority Data
Jun. 14, 2002 (JP) 2002-174566

(51) Int. Cl. H04N 1/04

(52) U.S. Cl. 358/498

(57) ABSTRACT

Image processing apparatus comprises recording unit for recording a document on recording paper; selecting unit for selecting paper to be fed to the recording unit, the selected paper being suitable for a paper size specified in the document; first paper feed tray capable of performing paper feeding according to selection by the selecting unit; second paper feed tray incapable of performing paper feeding according to selection by the selecting unit; setting unit for setting that the first tray is inhibited from performing the paper feeding according to selection by the selecting unit; and paper feed control unit for allowing the second tray to feed the paper, if the setting unit has set that the first tray is inhibited from performing the paper feeding according to selection by the selecting unit or if the first tray cannot perform the paper feeding according to selection by the selecting unit.

### BACKGROUND OF THE INVENTION

1. Field of the Invention

The present invention relates to an image processing apparatus and a paper feed control method, and more particularly to an image processing apparatus having facsimile, copier and printer functions, and to a paper feed control method therof.

2. Description of the Related Art

Conventional facsimile machines capable of printing on recording paper of different sizes are equipped with plural paper feed trays, each being loaded with recording paper of respective size. Such facsimile machines automatically select a paper feed tray loaded with recording paper of a size fitting with the size of a received image (this operation is called as “automatic feeding”), and print out the image on the selected recording paper.

Recently, composite image processing apparatuses having copier and printer functions in addition to facsimile function have been developed. In such a composite image processing apparatus, a paper feed tray may be loaded with recording paper such as recording paper for overhead projectors and thick paper which are not suited for printing out document or image received via facsimile communications. Therefore, if a paper feed tray is loaded with recording paper intended for a particular use other than printing of received facsimile, this paper feed tray must be inhibited from the automatic feeding.

Techniques for selecting paper feed trays according to the function of the composite apparatus currently being used or type of recording paper loaded therein have been proposed. For example, Japanese Patent Laid-Open No. 11-32139 discloses a technique in which a particular paper feed tray is set as a paper feed tray dedicated to the printer function among plural paper feed trays, and Japanese Patent Laid-Open No. 7-250190 discloses a technique in which a particular paper feed tray is set as a paper feed tray dedicated to incoming facsimile printing.

These techniques disclosed in the above publications, however, do not take into account a situation in which all of the paper feed trays are inhibited from the automatic feeding. In such a situation, there arises a problem that an incoming facsimile is rejected because it cannot be printed out because all paper feed trays are inhibited from automatic feeding, or the incoming facsimile is received without being printed out.

A composite image processing apparatus is often shared with plural users. Thus, in a composite apparatus that inhibits the automatic feeding for an incoming facsimile with respect to certain types of recording paper loaded in its paper feed trays, the above problem will arise if an incoming facsimile is received during a period where a user uses the composite apparatus as a copier or printer and loads recording paper of a type that inhibits the automatic feeding for incoming facsimile.

On the other hand, in a composite apparatus in which each of the paper feed trays is dedicated to respective function, the above problem will occur if an incoming facsimile is received during a period where the paper feed tray dedicated to the facsimile function, because the remaining paper feed trays are inhibited for automatic feeding for printing out the incoming facsimile even though recording paper are loaded therein.

To avoid the foregoing problem, a technique has been proposed for printing out image data through the use of a manual-feed tray on which a user manually loads recording paper of a type for a desired use. Generally, in the interests of cost or other reasons, the manual-feed tray is designed to be able to detect only the presence of recording paper loaded therein. It is not designed to be able to discriminate the size of the recording paper loaded therein. Therefore, the manual-feed tray cannot perform the automatic feeding.

Japanese Patent Laid-Open No. 2001-111769 discloses a technique in which in a situation where all paper feed trays cannot perform the automatic feeding for an incoming facsimile, if a manual-feed tray is loaded with recording paper, the receiving of the incoming facsimile is interrupted, and operations are controlled expecting that the facsimile will be retransmitted from the source machine.

However, the technique of Japanese Patent Laid-Open No. 2001-111769 causes a problem that a communication error occurs if the source machine does not have a re-transmission function.

### SUMMARY OF THE INVENTION

The present invention has been made in view of the above circumstances, and provides an image processing apparatus and a paper feed control method therefor, which allows, in addition to printing out an image on recording paper using a paper feed tray that is fitted for a user's purpose, to print out an image even if the paper feed tray fitted for the user's purpose becomes inoperable due to some reasons such as wrong setting by the user or a failure of the paper feed tray, and further allows to use the facsimile function without rejecting an incoming facsimile or without entering a unprintable state even if the automatic feeding is inhibited at the receiving of the incoming facsimile.

According to a first aspect of the present invention, an image processing apparatus comprises a recording unit for recording a document on recording paper; a paper feed selecting unit for selecting recording paper to be fed to the recording unit, the selected recording paper being suitable for a paper size specified in the document; a first paper feed tray capable of performing paper feeding according to the selection made by the paper feed selecting unit; a second paper feed tray incapable of performing paper feeding according to the selection made by the paper feed selecting unit; setting unit for setting the first paper feed tray so that the first paper feed tray is inhibited from performing the paper feeding according to the selection made by the paper feed selecting unit; and paper feed control unit for allowing the second paper feed tray to feed the recording paper, if the setting unit has set the first paper feed tray so that the first paper feed tray is inhibited from performing the paper feeding according to the selection made by the paper feed selecting unit or if the first paper feed tray cannot perform the paper feeding according to the selection made by the paper feed selecting unit.

According to a second aspect of the invention, a paper feed control method in recording a document on recording paper, wherein a first paper feed tray is capable of performing selective paper feeding for selecting and feeding recording paper suitable for a paper size specified by the document, and a second paper feed tray is incapable of performing the selective paper feeding, comprises the steps of detecting whether the first paper feed tray is set so that the first paper feed tray is inhibited from performing the selective paper feeding; detecting whether the first paper feed tray is in a condition in which the first paper feed tray cannot perform the selective paper feeding; and feeding recording paper from the second paper feed tray when it is detected that the first paper feed tray is set so that the first paper feed tray is inhibited from performing the selective paper feeding or it is detected that the first paper feed tray is in a condition in which the first paper feed tray cannot perform the selective paper feeding.

The present invention achieves the effect that printout is permitted even when a paper feed tray becomes unusable for some reason such as wrong settings of a paper feed tray by a user or a failure of a paper feed tray.

### BRIEF DESCRIPTION OF THE DRAWINGS

Embodiments of the present invention will be described in detail based on the follwing drawings, wherein:

FIG. 1 is a block diagram showing an exemplary schematic configuration of an image processing apparatus in accordance with the present invention;

FIG. 2 shows data stored in an auxiliary memory of the image processing apparatus concerning recording paper loaded in a paper feed tray and a manual-feed tray;

FIG. 3 shows setting data stored in the auxiliary memory that indicates automatic feeding is inhibited or permitted according to the type of recording paper;

FIG. 4 shows an example of a display'screen of a display device of the image processing apparatus, which notify a user that recording paper loaded in a manual-feed tray is selected for printing;

FIG. 5 is a flowchart illustrating a processing flow of paper feed control for a manual-feed tray performed by a CPU of the image processing apparatus;

FIGS. 6A and 6B show examples of a display screen displayed on the display device when an incoming facsimile is received;

FIG. 7 shows a flowchart illustrating a processing flow of paper feed control for a manual-feed tray performed by the CPU and a communication control device of the image processing apparatus when an incoming facsimile is received by the communication control device;

FIG. 8 shows data stored in the auxiliary memory concerning recording paper loaded in a paper feed tray and manual-feed tray;

FIG. 9 shows setting data stored in the auxiliary memory that indicates an automatic feeding function according to the paper feed tray; and

FIG. 10 is a flowchart illustrating a processing flow of paper feed control for a manual-feed tray performed by the CPU when the automatic feeding function is set according to the respective paper feed trays.

### DESCRIPTION OF THE EMBODIMENTS

Embodiments of an image processing apparatus and a paper feed control method according to the present invention will be explained in detail with reference to the accompanying drawings.

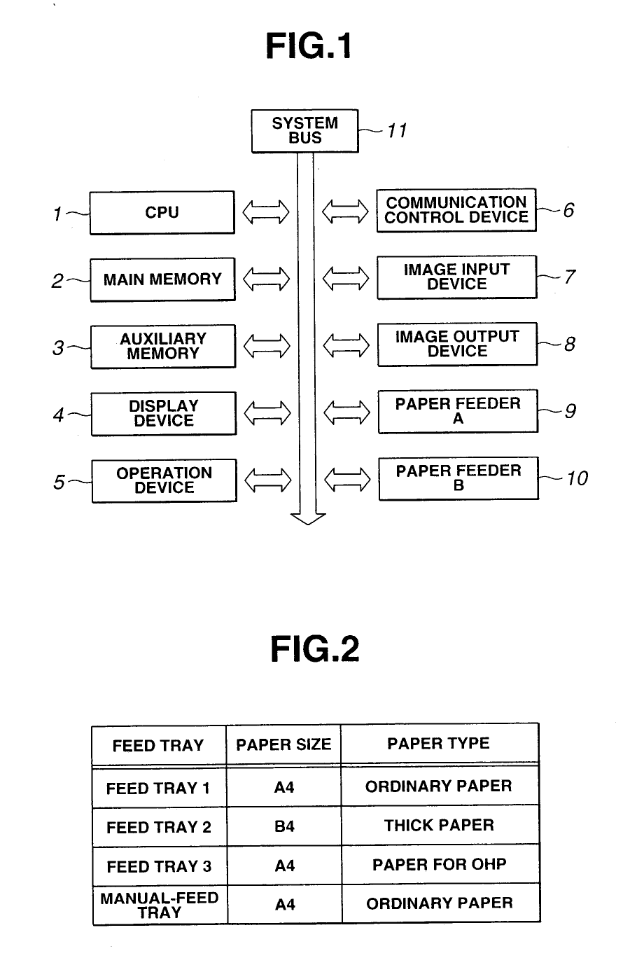

FIG. 1 is a block diagram showing an exemplary schematic configuration of an image processing apparatus of the present invention.

As shown in FIG. 1, the image processing apparatus comprises a CPU 1, a main memory 3, an auxiliary memory 3, a display device 4, a operation device 5, a communication control device 6, an image input device 7, an image output device 8, a paper feeder A9, a paper feeder B10, and a system bus 11.

The CPU 1 reads control programs stored in the main memory 2, controls paper feed operations of the paper feeders A9 and B10, and controls the whole image processing apparatus.

The main memory 2 stores therein a control program etc. of the image processing apparatus.

The auxiliary memory 3 stores data about paper size and type of recording paper loaded in the paper feeder A9, data on setting that the automatic feeding is inhibited or permitted according to the type of the recording paper, and data on setting the functions of the composite apparatus permitting the paper feed trays to the automatic feeding. The auxiliary memory 3 also temporarily stores an image of an original document scanned by the image input device 7 and an image received through the communication control device 6.

The display device 4 comprises a liquid crystal display device or the like for displaying various data such as the state of the image processing apparatus, the communication state, and messages to user.

The operation device 5 comprises a touch panel, a keyboard or the like and is used for inputting instructions and settings for each device of the image processing apparatus, for instructing a start timing of communications, and for setting a destination machine.

The communication control device 6 controls image communications for transmitting and receiving image data via public lines, networks or the like.

The image input device 7 comprises a scanner or the like for reading out original documents or the like as image data to be transmitted via communication networks or to be printed out by the image processing apparatus.

The image output device 8 prints an image read out by the image input device 7 and an image received via a communication network or from recording paper.

The paper feeder A9 is a multi-stacked tray assembly comprising a paper feed trays 1, 2, and 3 (not shown) capable of the automatic feeding. Although an embodiment of the present invention will be described below in the configuration that a three-stacked tray assembly is used by way of example, it should be understood that the number of stacked trays may be four or more. The user can instruct to inhibit or permit the automatic feeding for each of the paper feed trays 1, 2, and 3 through the operation device 5. If it is instructed to print on both sides of recording paper through the operation device 5, both-sides printing is performed on the recording paper that is automatically fed from the paper feeder A9.

In this embodiment, it is assumed that the paper feeder B10 is a manual-feed tray (not shown) on which a user can load desired type of recording paper for a his/her particular use. The manual-feed tray cannot perform the automatic feeding. Although this embodiment is described assuming that the paper feeder B10 is a manual-feed tray, it may be configured that the multi-stacked tray assembly is constituted by paper feed trays 1-4 in which the paper feeder A9 comprises the paper feed trays 1-3 that can be set to inhibit the automatic feeding, while the paper feeder B10 comprises the paper feed tray 4 that cannot be set to inhibit the automatic feeding. In this configuration, when recording paper is fed from the paper feeder B10, even if both-sides printing on recording paper is instructed through the operation device 5, one-side printing is performed by ignoring the instruction.

Various data are exchanged between the respective devices of the image processing apparatus via the system bus 11.

In the following, paper feed control processing performed by the manual-feed tray in the image processing apparatus will be described in detail.

In the first embodiment, a user sets that the automatic feeding is inhibited or permitted according to the type of recording paper loaded in a paper feed tray.

FIG. 2 shows data concerning recording paper loaded in the paper feed trays and manual-feed tray stored in an auxiliary memory 3 of the image processing apparatus.

The table in FIG. 2 shows an example of a tray data on the size and type of paper loaded on feed trays. In the table, the data that the paper feed tray I is loaded with an A4-size ordinary paper; the paper feed tray 2 is loaded with a B4-size thick paper; the paper feed tray 3 is loaded with an A4-size paper for overhead projectors; and the manual-feed tray is loaded with an A4-size ordinary paper. The size and type of the recording paper are automatically detected each time the recording paper loaded in the paper feed trays or manual-feed tray is replaced, and the tray data is accordingly updated to the newest contents. If the paper feed trays and manual-feed tray are the type that cannot detect the size and type of paper automatically, the size and type of the recording paper may be entered manually by a user through the operation device 5 each time any recording paper is replaced.

Then, the user instructs through the operation device 5 to inhibit or permit the automatic feeding according to the type of the recording paper.

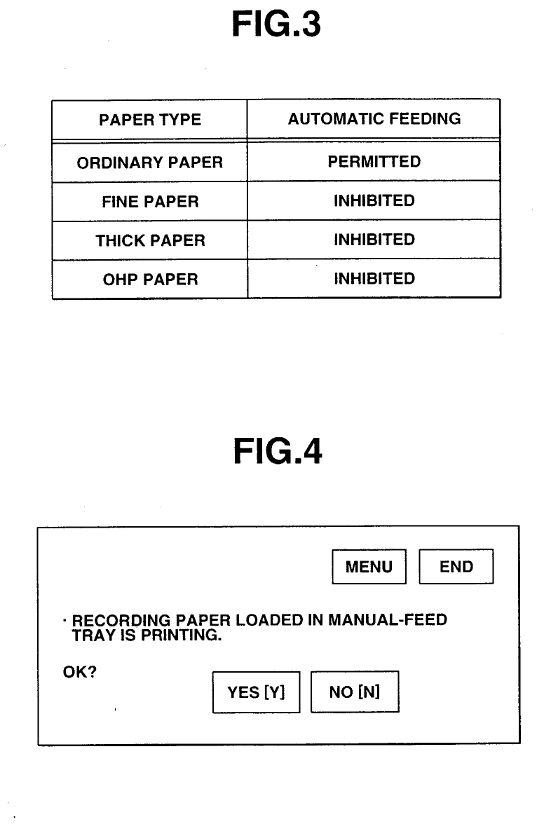

FIG. 3 shows automatic feeding data stored in the auxiliary memory 3 that indicates that the automatic feeding is inhibited or permitted according to the type of respective recording paper.

As shown in FIG. 3, the automatic feeding data includes the following data: the automatic feeding is permitted if the type of the recording paper is “ordinary paper”; inhibited if “fine paper”; inhibited if “thick paper”; and inhibited if “paper for overhead projectors (OHP)”.

Based on the automatic feeding data, the CPU 1 selects a paper feed tray to be used for automatically feeding recording paper when an image output device 8 prints an image on recording paper. For example, according to the automatic feeding data illustrated in FIG. 3, the automatic feeding is permitted only for “ordinary paper”. Combined this data with the tray data illustrated in FIG. 2, it is identified that only the paper feed tray 1 is permitted the automatic feeding.

In the case that the recording paper loaded in the paper feed tray 1 is replaced with recording paper having the type other than ordinary paper or in the case that the automatic feeding becomes disabled because of some reasons such as a failure of the paper feed tray 1, the image processing apparatus notifies the user that recording paper loaded in the manual-feed tray is selected for printing, and confirm to the user whether or not the user agrees to feed recording paper from the manual-feed tray.

FIG. 4 shows an example of a display screen on the display device 4 of the image processing apparatus, for notifying the user that printout is performed on recording paper fed from the manual-feed tray.

As shown in FIG. 4, the image processing apparatus displays on the display device 4 a message “Recording sheet loaded in the manual-feed tray is printing” which notifies the user that printout will be performed by feeding recording paper from the manual-feed tray, and confirms to the user whether or not the user agrees to feed recording paper from the manual-feed tray.

Upon reading the screen message such as shown in FIG. 4, if the user agrees with feeding recording paper from the manual-feed tray, the user activates a button “Y (yes)”. When the CPU 1 confirms that such feeding from the manual-feed tray is permitted, it feeds recording paper loaded in the manual-feed tray and starts printing. On the other hand, if the user does not agree with feeding recording paper from the manual-feed tray, the user activates a button “N (no)”. When the CPU 1 confirms that such feeding is not permitted, it does not feed recording paper loaded in the manual-feed tray for printout, but waits until the automatic feeding from the paper feed tray becomes permitted in the event that the automatic feeding data is changed or the recording paper in the paper feed tray is replaced.

Note that when recording paper is fed from the manual-feed tray, even though both-sides printing on recording paper is instructed through the operation device 5, one-side printing is performed by ignoring the instruction.

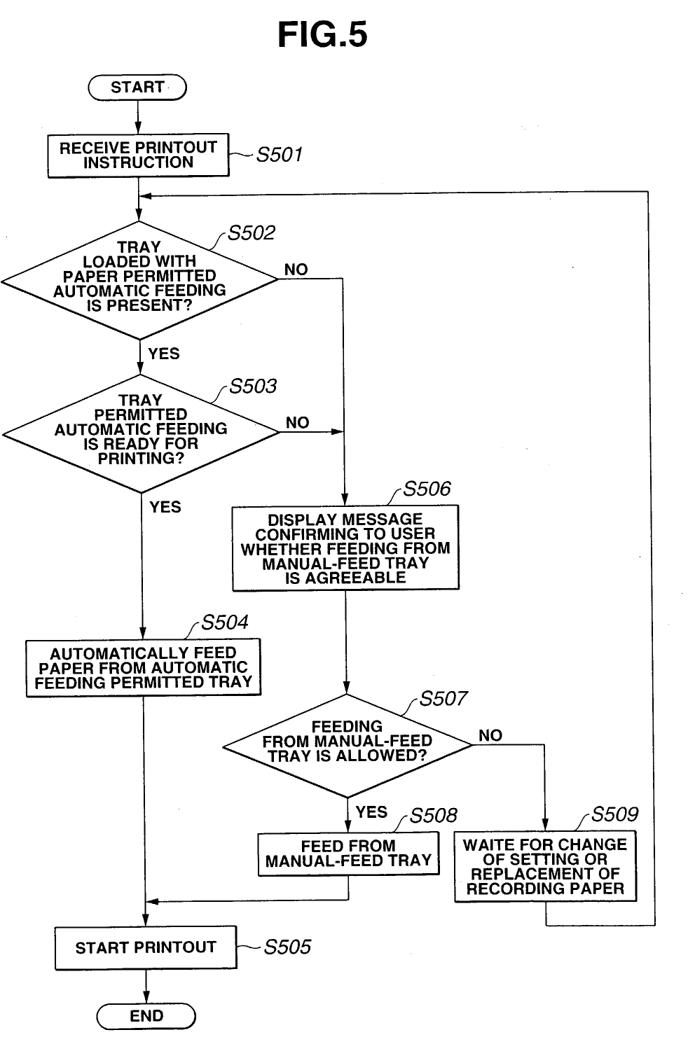

In the following, a processing flow of the paper feed control for the manual-feed tray performed by the CPU 1 will be described with reference to the flowchart of FIG. 5.

When the CPU 1 receives the instruction to print out the image data received by the communication control device via a communication network or to print out the image data scanned by the image input device (step S501), the CPU 1 references the tray data (FIG. 2) and the automatic feeding data (FIG. 3) stored in the auxiliary memory to determine whether or not there exists a paper feed tray which is loaded with recording paper of the type permitted the automatic feeding (step S502).

If it is determined in step S502 that the paper feed tray which is loaded with recording paper of the type permitted the automatic feeding exists (i.e., the answer in step S502 is YES), then it is determined whether or not the paper feed tray permitted the automatic feeding is ready for printout (step S503). If the paper feed tray is ready for printout (i.e., the answer in step S503 is YES), recording paper is fed from the paper feed tray permitted the automatic feeding (step S504), an image is printed on the automatically fed recording paper (step S505), and the processing flow terminates.

On the other hand, if it is determined in step S502 that the paper feed tray which is loaded with recording paper of the type permitted the automatic feeding does not exist (i.e., the answer in step S502 is NO), or it is determined in step S503 that the paper feed tray is not ready for printout (i.e., the answer in step S503 is NO), the display device displays the message for confirming to the user whether or not the user agrees with feeding recording paper from the manual-feed tray (step S506). If the user agrees with feeding recording paper from the manual-feed tray (i.e., the answer in step S507 is YES), recording paper is fed from the manual-feed tray (step S508), an image is printed on the fed recording paper (step S505), and the processing flow terminates.

If it is determined in step S507 that the user does not agree with feeding recording paper from the manual-feed tray (i.e., the answer in step S507 is NO), the processing flow waits until the automatic feeding setting is changed or until the recording paper allowed to be automatically fed in the paper feed tray is loaded within the paper feed tray. When the automatic feeding setting is changed or the recording paper in the paper feed tray is replaced, the processing flow returns to step S502.

As described in the foregoing, the present invention allows printout by feeding recording paper from a manual-feed tray when a paper feed tray capable of the automatic feeding cannot feed recording paper for some reasons such as wrong settings or a failure.

Next, paper feed control processing for the manual-feed tray performed by the CPU 1 in the first embodiment when the communication control device 6 receives an incoming facsimile will be described in detail. The configuration of the image processing apparatus is the same as shown in FIG. 1, the tray data stored in the auxiliary memory 3 is the same as shown in FIG. 2, and the automatic feeding data is the same as shown in FIG. 3.

When the communication control device 6 starts receiving an incoming facsimile, a paper feed tray used for automatically feeding recording paper is selected based on the automatic feeding data. For example, based on the automatic feeding data illustrated in FIG. 3, it is found that the automatic feeding is permitted only for “ordinary paper”. Combined this data with the tray data illustrated in FIG. 2, it is identified that only the paper feed tray 1 can automatically feed recording paper, and therefore the CPU 1 instructs to automatically feed recording paper from the paper feed tray 1. As the recording paper loaded in the paper feed tray 1 is an A4-size sheet, the communication control device 6 notifies a source machine sending the incoming facsimile that the receivable paper size is A4, and then receives the incoming facsimile image of A4-size from the source machine.

At this time, the CPU 1 causes the display device 4 to display a message notifying the user that an incoming facsimile is received in A4-size which is the same size as that of the recording paper loaded in the paper feed tray 1.

If the recording paper loaded in the paper feed tray 1 has been replaced with recording paper having the type other than ordinary paper or if the paper feed tray 1 becomes disabled to feed recording paper because of a failure or the like, the communication control device 6 informs the source machine of every paper sizes that can be loaded in the manual-feed tray as receivable paper sizes, and receives from the source machine the incoming facsimile image in any paper size adaptable for the manual-feed tray.

At this time, the CPU 1 causes the display device 4 to display a message notifying the user that an incoming facsimile is received in any paper size adaptable for the manual-feed tray.

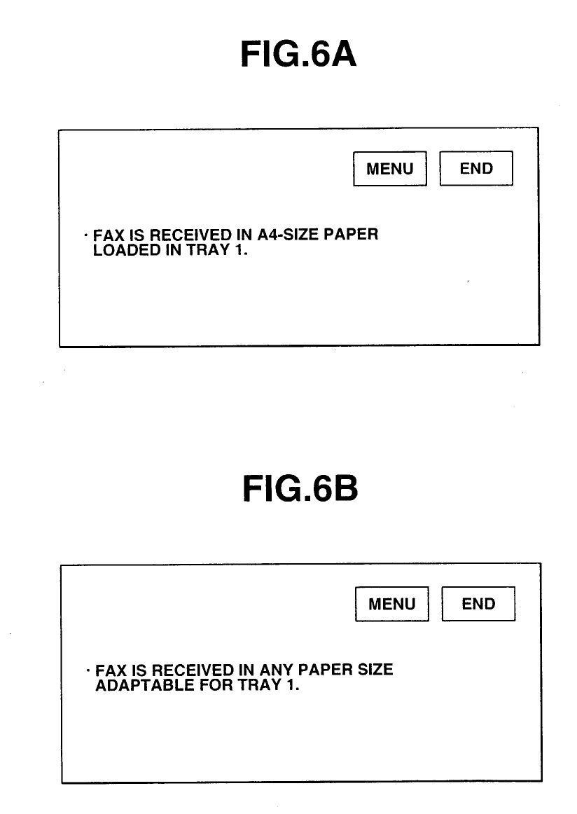

FIGS. 6A and 6B show, by way of example, display screens displayed on the display device 4 of the image processing apparatus when an incoming facsimile is received.

FIG. 6A shows a message “Facsimile is received in A4 size that is set for the paper feed tray 1” notifying the user that an incoming facsimile is received in A4-size which is the same size as that of recording paper loaded in the paper feed tray 1.

Then, the communication control device 6 continues the receiving of the incoming facsimile, and upon completion of the facsimile receipt, recording paper is automatically fed from the paper feed tray 1 and the image received through the facsimile is printed on the recording paper.

FIG. 6B shows a message “Facsimile is received in any paper size adaptable for the manual-feed tray” displayed notifying that the user that an incoming facsimile is received in any paper size adaptable for the manual-feed tray.

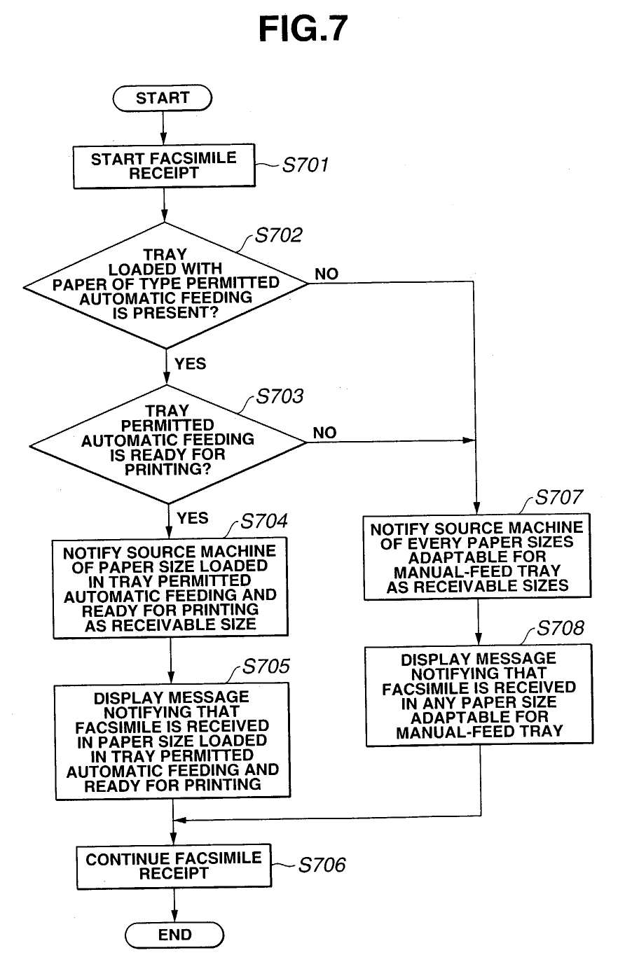

The communication control device 6 continues the facsimile receipt. After completion of the facsimile receipt, the received image may be temporarily stored in the auxiliary memory 3 until the user instructs printout thereof FIG. 7 shows a flowchart illustrating a processing flow of paper feed control for a manual-feed tray performed by the CPU 1 and the communication control device 6 when an incoming facsimile is received by the communication control device 6.

When the communication control device 6 starts receiving an incoming facsimile (step S701), the CPU references the tray data and the automatic feeding data stored in the auxiliary memory, to determine whether or not a paper feed tray which is loaded with recording paper of the type permitted the automatic feeding exists (step S702).

If it is determined that a paper feed tray which is loaded with recording paper of the type permitted the automatic feeding exists (i.e., the answer in step S702 is YES), then it is determined whether or not the paper feed tray permitted the automatic feeding is ready for printout (step S703). If the paper feed tray is ready for printout (i.e., the answer in step S703 is YES), the communication control device notifies a source machine of the paper size assigned to the paper feed tray permitted the automatic feeding as the receivable paper size (step S704), the CPU 1 displays on the display device 4 a message notifying the user that an incoming facsimile image is received in the size of the recording paper loaded in the paper feed tray permitted the automatic feeding (step S705), the communication control device continues the facsimile receipt (step S706), and the processing flow terminates.

On the other hand, if it is determined in step S702 that a paper feed tray which is loaded with recording paper of the type permitted the automatic feeding does not exist (i.e., the answer in step S702 is NO), or if it is determined in step S703 that the paper feed tray permitted the automatic feeding is not ready for printout (i.e., the answer in step S703 is NO), then the communication control device 6 informs the source machine of all the paper sizes adaptable for the manual-feed tray as the receivable paper sizes (step S707), the CPU 1 display a message on the display device 4 for notifying the user that an incoming facsimile image is received in any paper size adaptable for the manual-feed tray (step S708), the communication control device continues the facsimile receipt (step S706) and the processing flow terminates.

As described in the foregoing, the present invention allows to continue the facsimile receipt by receiving an incoming facsimile image in any paper size adaptable for the manual-feed tray even when a paper feed tray capable of the automatic feed sheet cannot feed recording paper for some reasons such as wrong settings or a failure.

Next, the second embodiment in which a user sets a function which permits the automatic feeding according to the respective paper feed trays will be explained by way of example.

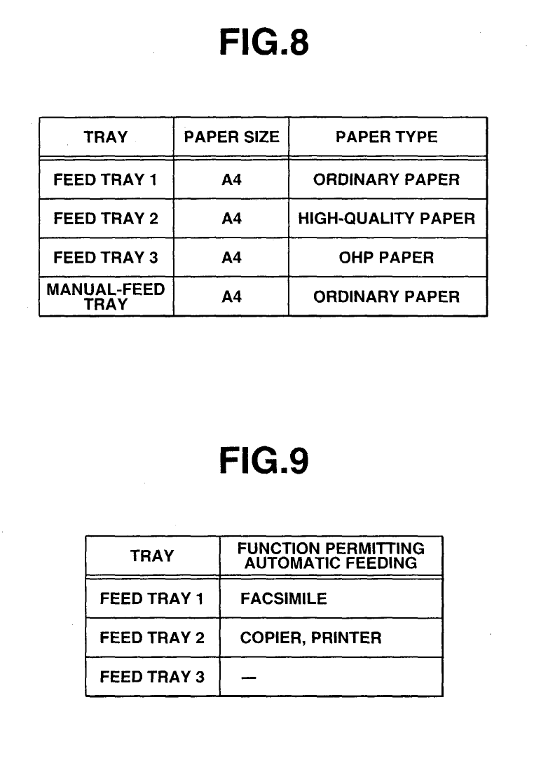

FIG. 8 shows a tray data stored in the auxiliary memory 3 concerning the size and type of the recording paper loaded in the paper feed trays and manual-feed tray.

In FIG. 8, the tray data includes the data that a paper feed tray 1 is loaded with an A4-size ordinary paper, a paper feed tray 2 is loaded with a B4-size thick paper, a paper feed tray 3 is loaded with an A4-size paper for overhead projectors, and a “manual-feed tray” is loaded with an A4-size ordinary paper. The size and type of the recording paper are automatically detected each time the recording paper loaded in the paper feed tray or manual-feed tray is replaced, and the tray data is accordingly updated to the newest contents. If the paper feed trays and the manual-feed tray are of type that is not capable of the automatic detection on the size and type of recording paper, the size and type of recording paper may be entered by a user through the operation device 5 each time the recording paper is replaced.

Then, the user sets the function which permits the automatic feeding for each paper feed tray through the operation device 5.

FIG. 9 shows automatic feeding data stored in the auxiliary memory 3, concerning the functions permitting the automatic feeding according to the paper feed trays.

In FIG. 9, the automatic feeding data contains the following data: the paper feed tray 1 is permitted the automatic feeding under the printout mode of the facsimile function, the paper feed tray 2 is permitted the automatic feeding under the printout mode of the printer function.

Based on the automatic feeding data, the CPU 1 selects a paper feed tray to be used for automatically feeding recording paper when an image output device 8 prints an image on recording paper. For example, when an incoming facsimile is received, recording paper is fed from the paper feed tray 1 because the paper feed tray permitted automatic feeding of recording paper under the printout mode of the facsimile function is the paper feed tray 1 only according to the automatic feeding data shown in FIG. 9.

If the automatic feeding becomes disabled because of a failure or the like of the paper feed tray 1 under the printout mode of the facsimile function or if the automatic feeding becomes disabled because of a failure or the like of the paper feed tray 2 under the printout mode of the copier or printer function, printout is performed by feeding recording paper from the manual-feed tray. On the other hand, if a paper feed tray which is permitted the automatic feeding with respect to the function selected by the user to print out an image does not exist, printout is also performed by feeding recording paper from the manual-feed tray.

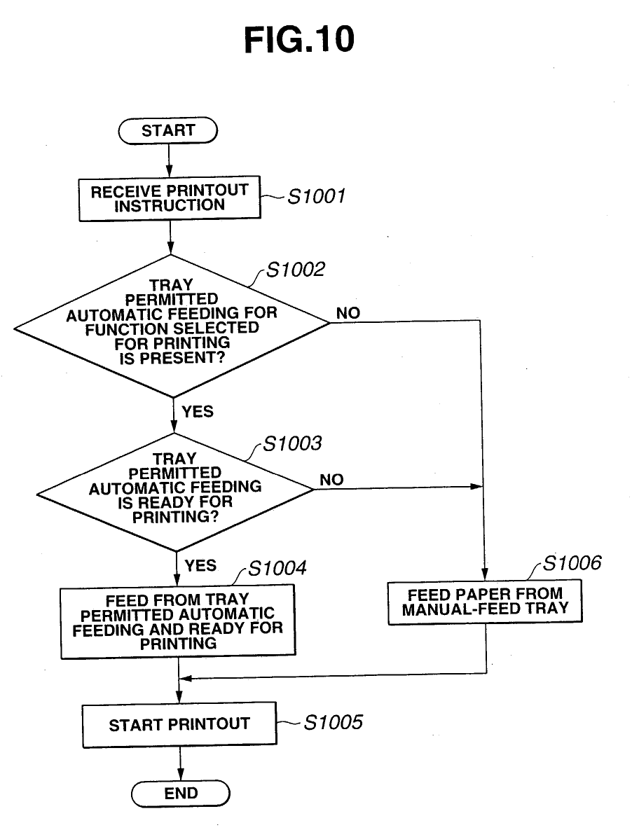

Referring now to the flowchart of FIG. 10, a processing flow of the paper feed control for the manual-feed tray performed by the CPU 1 when a function which permits the automatic feeding is set according to the respective paper feed trays will be described.

When the CPU 1 receives the instruction to print out image data received by the communication control device 6 via a communication network or image data scanned by the image input device (step S1001), the CPU 1 references the tray data and the automatic feeding data stored in the auxiliary memory 3 to determine whether or not there exists a paper feed tray which is permitted the automatic feeding with respect to the function selected by the user to print out the image data (step S1002).

If it is determined in step S1002 that the paper feed tray permitted the automatic feeding exists (i.e., the answer in step S1002 is YES), then it is determined in step S 1003 whether or not the paper feed tray permitted the automatic feeding is ready for printout. If ready for printout (i.e., the answer in step S1003 is YES), recording paper is fed from the paper feed tray permitted the automatic feeding (step S1004), an image is printed on the automatically fed recording paper (step S1005), and the processing flow terminates.

On the other hand, if it is determined in step S1002 that a paper feed tray permitted the automatic feeding does not exist (i.e., the answer in step S1002 is NO), or if it is determined in step S1003 that the paper feed tray permitted the automatic feeding is not ready for printout (i.e., the answer in step S1003 is NO), recording paper is fed from the manual-feed tray (step S1006), an image is printed on the recording paper (step S1005), and the processing flow terminates.

In case that a paper feed tray, which is permitted the automatic feeding with respect to the function selected by the user to print out an image, does not exist, or if the paper feed tray permitted the automatic feeding is not ready for printout, the image processing apparatus may be so configured that the display device 4 visually inform the user that printout will be performed by feeding recording paper from the manual-feed tray and confirm to the user whether or not the user agrees to feed recording paper from the manual-feed tray.

As described in the foregoing, the present invention allows printout by feeding recording paper from a manual-feed tray even when a paper feed tray capable of the automatic feeding cannot feed recording paper for some reasons such as wrong setting or a failure.

What is claimed is:

1. An image processing apparatus comprising:
recording means for recording a document on recording paper;
paper feed selecting means for selecting recording paper to be fed to the recording means, the selected recording paper being suitable for a paper size specified in the document;
a first paper feed tray capable of performing paper feeding according to the selection made by the paper feed selecting means;
a second paper feed tray incapable of performing paper feeding according to the selection made by the paper feed selecting means;
setting means for setting the first paper feed tray so that the first paper feed tray is inhibited from performing the paper feeding according to the selection made by the paper feed selecting means; and
paper feed control means for allowing the second paper feed tray to feed the recording paper, if the setting means has set the first paper feed tray so that the first paper feed tray is inhibited from performing the paper feeding according to the selection made by the paper feed selecting means or if the first paper feed tray cannot perform the paper feeding according to the selection made by the paper feed selecting means.

2. The image processing apparatus according to claim 1, further comprising notification means for notifying a user that the recording paper will be fed from the second paper feed tray when the paper feed tray control means allows the second paper feed tray to feed the recording paper.

3. The image processing apparatus according to claim 2, further comprising confirmation means for confirming to the user whether or not the user agrees to feed recording paper from the second paper feed tray when the notification means notifies the user that the recording paper will be fed from the second paper feed tray.

4. The image processing apparatus according to claim 1, further comprising selection means for selecting one-side printing in which the document is recorded on one side of the recording paper or both-sides printing in which the document is recorded on both sides of the recording paper,
wherein the recording means records the document on the recording paper in accordance with the selection made by the selection means when the paper feed selecting means selects feeding of recording paper from the first paper feed tray, and the recording means performs the one-side printing on the recording paper irrespective of the selection made by the selection means when the recording paper is fed from the second paper feed tray.

5. The image processing apparatus according to claim 1, wherein the setting means sets that feeding of recording paper selected according to the selection by the paper feed selecting means is inhibited or not for each type of the recording paper.

6. The image processing apparatus according to claim 1, wherein the second paper feed tray is a manual-feed tray into which a user loads recording paper of desired size and type.

7. The image processing apparatus according to claim 1, further comprising:
facsimile communication means for carrying out facsimile communications with another party; and
transmitting means for transmitting data to the another party with any paper size that can be fed from the second paper feed tray as a paper size that is receivable to the another party, if the setting means has set that the first paper feed tray is inhibited from performing the operations according to the selection made by the paper feed selecting means or if the first paper feed tray cannot perform paper feeding according to the selection made by the paper feed selecting means.

8. A paper feed control method in recording a document on recording paper, wherein a first paper feed tray is capable of performing selective paper feeding for selecting and feeding recording paper suitable for a paper size specified by the document, and a second paper feed tray is incapable of performing the selective paper feeding, comprising the steps of:
detecting whether the first paper feed tray is set so that the first paper feed tray is inhibited from performing the selective paper feeding;
detecting whether the first paper feed tray is in a condition in which the first paper feed tray cannot perform the selective paper feeding; and
feeding recording paper from the second paper feed tray when it is detected that the first paper feed tray is set so that the first paper feed tray is inhibited from performing the selective paper feeding or it is detected that the first paper feed tray is in a condition in which the first paper feed tray cannot perform the selective paper feeding.

9. The paper feed control method according to claim 8, further comprising the step of notifying a user that recording paper is fed from the second paper feed tray when the document is to be recorded on the recording paper fed from the second paper feed tray.

10. The paper feed control method according to claim 10, further comprising the step of determining whether the user agrees that the recording paper is fed from the second paper feed tray when the user is notified that the, recording paper is fed from the second paper feed tray.

11. The paper feed control method according to claim 8, further comprising the steps of:
selecting both-sides printing in which the document is recorded on both sides of the recording paper or one-side printing in which the document is recorded on one side of the recording paper;
recording the document on the recording paper in accordance with the selection made by the selecting step when the first paper feed tray performs the selective paper feeding; and
recording the document on the recording paper in the one-side printing irrespective of the selection made by the selecting step when the recording paper is fed from the second, paper feed tray.

12. The paper feed control method according to claim 8, further comprising the steps of:
detecting a type of the recording paper; and
determining whether the first paper feed tray is set so that the selective paper feeding is inhibited.

13. The paper feed control method according to claim 8, wherein the second paper feed tray is a manual-feed tray in which a user loads recording paper of desired size and type.

14. A paper feed control method in recording a document on recording paper, wherein a first paper feed tray is capable of performing selective paper feeding for selecting and feeding recording paper suitable for a paper size specified by the document, and a second paper feed tray is incapable of performing the selective paper feeding, comprising the steps of:
detecting whether the first paper feed tray is set so that the first paper feed tray is inhibited from performing the selective paper feeding;
detecting whether the first paper feed tray is in a condition in which the first paper feed tray cannot perform the selective paper feeding; and
transmitting data to another party in facsimile communications with the another party with any paper size that can be fed from the second paper feed tray as a paper size that is receivable to the another party, when it is detected that the first paper feed tray is set so that the first paper feed tray is inhibited from performing the selective paper feeding or it is detected that the first paper feed tray is in a condition in which the first paper feed tray cannot perform the selective paper feeding.
